(19) United States
(12) Patent Application Publication
(10) Pub. No.: US 2007/0143184 A1
(43) Pub. Date: Jun. 21, 2007

(54) Method of Facilitating Advertising Research and Use of the Method

(75) Inventor: Jeffrey P. Szmanda, Milwaukee, WI (US)

Correspondence Address: CHARLES R. SZMANDA, 4 CROSSMAN AVENUE, WESTBOROUGH, MA, 01581, US

(73) Assignee: MADISON AVENUE TOOLS, INC, Milwaukee, WI (US)

(21) Appl. No.: 11/608,748

(22) Filed: Dec. 8, 2006

Related U.S. Application Data
(60) Provisional application No. 60/750,669, filed on Dec. 15, 2005.

(51) Int. Cl. G06Q 30/00

(52) U.S. Cl. 705/14

(57) ABSTRACT

This disclosure provides a method of facilitating advertising research by providing a plurality of individual customer inputs, said plurality of individual customer inputs being obtained from searches by one or more customers using a customer response facilitation system, and characterized in that the final output of each search session includes at least one advertisement sought by the individual customer; computing the accuracy of the customer inputs relative to the advertiser's targeted advertisement or advertisements; and computing the precision of the customer inputs.

### REFERENCE TO PRIOR APPLICATION

This application claims the benefit of the previously filed provisional application No. 60/750,669 filed on 15 Dec., 2005, which application is incorporated by reference in its entirety.

### FIELD

The present invention generally relates to the field of advertising research, and specifically relates to a method of facilitating advertising research wherein data from response facilitation are employed to measure the accuracy and precision of customer response.

### BACKGROUND

The advent of the Internet has resulted in the ability to communicate data across the globe instantaneously, and will allow for numerous new applications that enhance consumer's lives. One of the enhancements that can occur is the ability of the consumer to retrieve information rapidly that is relevant to his or her lifestyle and interests at any time the consumer wishes, instead of accepting programmed information on media such as radio, television, print, public displays such as billboards, internet banner advertisements and the like.

In particular, advertising captures the consumer's attention at times when the consumer is unable or unwilling to pay sufficient attention to allow retention of potentially useful details such as, but not limited to, product characteristics, price and/or terms of sale, product options, availability, purchase venue, advertiser contact information and brand. In addition, consumers do not necessarily make purchase decisions at the time the advertisement is presented or seen. For example, the consumer might be made aware of the existence of a new product because of an advertisement. The decision to buy that product or to view that product as desirable may require some time after the advertisement is experienced because the customer may require more information or time to think about the purchase or may be busy doing something else may not see any reason to respond or may wish to consult his or her spouse. During such a period of time, referred to herein as the ideation period, details such as those above may be lost from the consumer's memory; the consumer may have only the general perception that the product is desirable or may have formed no perception at all. Nevertheless, the advertising may have made an impression on the consumer. Such an impression may be vague or highly specific.

A decision to purchase a product may evolve over the course of the ideation period, even as the consumer's memory of advertised details erodes. Such details comprise product characteristics, price and/or terms of sale, product options, availability, purchase venue, brand and advertiser contact information. It is known in the advertising art that advertisements laden with such detail must be repeated frequently so that consumers can be reminded and retain sufficient information to enable a purchase decision and subsequent consummation of a purchase. However, advertising is done at great expense and unnecessary repetition must be avoided.

It is known in the art of advertising that the advertisement's content is communicated to consumers who are under many different circumstances. Accordingly, the advertiser must compete for the consumer's attention in a way that makes a lasting impression on the consumer's memory. Advertisements that exhibit a high level of salience are known to make lasting impressions on consumers. Such impressions may be either favorable or unfavorable and can be highly precise or vague. However, an advertisement that exhibits a high degree of salience will often elicit a strong response from the intended customer.

Communication of advertising content is accomplished through media that convey sensory input such as visual, auditory, tactile, olfactory and taste input to the consumer. Without intending to be bound by theory, it is believed that such sensory input can convey levels of meaning, depending on the sense to which the advertiser is appealing. By relying on multiple levels of meaning, the advertiser frequently employs ambiguity so that the message of the advertisement will appeal to the broadest audience that finds the advertisement relevant. In addition, advertisers are known in the art to employ a range of sensory queues that are meant to connect in some way with the consumer's experience. Because consumers come from a wide range of backgrounds, some sensory queues may connect strongly with the consumer's experience while others do not connect at all. Having experienced the advertisement, the consumer may have difficulty describing his or her reaction precisely. Such imprecision may or may not be desirable from the standpoint of the advertiser and frequently inevitable, particularly in circumstances where there is ambiguity about meaning.

As an example, an advertiser might choose specific words that are rich in connotative meaning, wherein connotative meaning is defined as that which signifies more than the literal meaning of a given word or phrase. Further, such connotative meaning might differ across geographical, ethnic, religious or cultural boundaries. Connotations can evoke both negative and positive reactions in consumers. While it may be desirable to avoid offending certain groups by using words that carry offensive connotative meaning, evoking a negative reaction may not always be undesirable from the standpoint of the advertiser. Such words may elicit a strong reaction in the consumer, which may be useful in inducing the consumer to remember the content of the advertisement. Nevertheless, the feelings evoked by such an advertisement may be difficult to describe in words.

As another example, other forms of communication can be transmitted through audio channels and are known in the art to enhance the message conveyed in an advertisement. For example, musical elements such as harmony, rhythm, meter and the like can be used to enhance the tone and mood of an advertisement to suggest cultural identity, sense of urgency, demographic appeal, type of enjoyment and the like. For example, melodies using the pentatonic minor scale may be used to identify the product with Asian, African or Native American culture, depending on the types of rhythm that are employed in combination. On the other hand, the addition of the flatted fifth to the pentatonic minor scale, when used with syncopated rhythm, may suggest a bluesy or jazzy mood that enhances the image of the product by identifying it with being “cool” or “hip.” Nevertheless, the consumer may not be sufficiently aware of such devices to describe them precisely but may only be able to describe his or her feelings that were evoked by the advertisement.

From the standpoint of the advertiser, it is desirable to reach target markets, usually comprising specific demographic segments. As used herein, a demographic segment is a subset of a population of individuals segmented by factors including but not limited to age, ethnic background, race, geographic location, sex, political preference, occupation, income, religion, sexual preference, avocations and hobbies, musical preference, other entertainment preferences, education, economic status, distance from workplace, housing type and automobile preferences as well as a combination of any of the foregoing. For products with narrow appeal, such targeting is probably sufficient to cover the contextual advertising space necessary to achieve a high level of saliency with the specific targeted population. When products have a more broad appeal, however, it may be desirable to address specific demographic segments by targeting different advertisements to different groups. Under such circumstances, each advertisement would be presented in such a way as to achieve a high level of saliency and specific positioning within the various targeted demographic segments while maintaining the desired product image and other commonalities consistently across the demographic spectrum.

There exists a system of response facilitation, that aids consumers in recalling information, based on their own impressions of advertisements (which may be nuanced, vague or somewhat inaccurate), particularly when the attempted retrieval is not contemporaneous with the presentation of the advertisement. In this system, customers use their own words, which may possess varying degrees of precision, as input to the response facilitation system that retrieves specific details concerning the content of one or more advertisements. In this system, customers input their impressions of one or more advertisements into a response facilitation system that retrieves and supplies specific details that enable behaviors or actions consistent with the intention of the advertiser whether or not such details were present in the original advertisement(s). A description of such an example of a response facilitation system has been published by Szmanda in published application US20030078838, incorporated herein by reference.

Conventional focus groups have been used to provide advertisers with data that allows determination of whether advertisements have their intended effect on customers. However, such research is costly, time consuming and requires an assembly of volunteers. Further, since the size of such an assembly determines the statistical significance of the measurement of customer response, repeated use of ever larger focus groups may be necessary. In addition, conventional focus groups provide a “snapshot” of customer responses but obtaining data over time will incur even more cost.

Therefore, a method of facilitating and doing advertising research is required that relies for input on data gathered in situ from response facilitation without using conventional focus groups. Such data would be gathered at reduced cost, and provide a “snapshot” view of customer responses as well as a view over time. Further, the statistical significance of the data would grow as the number of responses increased.

### DESCRIPTION

According to a first broad aspect, this invention provides a method of facilitating advertising research by providing a plurality of individual customer inputs, said plurality of individual customer inputs being obtained from searches by one or more customers using a customer response facilitation system, and characterized in that the final output of each search session includes at least one advertisement sought by the individual customer; computing the accuracy of the customer inputs relative to the advertiser's targeted advertisement or advertisements; and computing the precision of the customer inputs.

According to a second broad aspect, this invention provides a method of facilitating advertising research, by providing a plurality of individual customer inputs, said plurality of individual customer inputs being obtained from searches by one or more customers using a customer response facilitation system, and characterized in that the final output of each search session includes at least one advertisement sought by the individual customer; sorting the inputs into groups according to one or more demographic segments; computing the accuracy of the customer inputs within in each group relative to the advertiser's targeted advertisement or advertisements; and computing the precision of the customer inputs within each group.

According to a third broad aspect, this invention provides a method of facilitating advertising research by providing a plurality of individual customer inputs, said plurality of individual customer inputs being obtained from individual searches by one or more customers using a customer response facilitation system, and characterized in that the final output of each search session includes at least one advertisement sought by the individual customer; sorting the inputs into groups such that the final outputs of the search sessions in each group correspond to different advertisements; computing the accuracy of the sorted customer inputs within each group relative to the advertiser's targeted advertisement or advertisements; and computing the precision of the customer inputs within each group.

In each of the above broad aspects of the invention, the customer response facilitation system (a search based system) can be as disclosed by Szmanda in published application US20030078838 wherein the inputs are obtained by receiving, from the user, one or more search rules comprising facts about an advertisement. In one broad aspect of that disclosure, the response facilitation system then accesses a database comprising details of a plurality of advertisements and uses a search engine to apply said search rules to the database; and reports, to the user, results comprising a subset of the contents of said database. Alternatively, the response facilitation system of Szmanda, supra, can query the user to obtain one or more search rules comprising facts about an advertisement. Results are obtained by accessing a database comprising details of a plurality of advertisements; using a search engine to apply the search rules to the database to obtain a plurality of results comprising a first subset of the contents of the database; receiving one or more keywords from the user; using the keywords and the search engine to query the first subset; and reporting, to the user, results comprising a second subset of the contents of the database, wherein the second subset is smaller than said first subset. As a further alternative, the response facilitation system of Szmanda, supra, is used to query the user to obtain one or more search rules comprising facts about an advertisement; access a database comprising details of a plurality of advertisements; use a first search engine to apply the search rules to the database to obtain results comprising a first subset of the contents of the database; receive from the user one or more keywords; use the keywords and a second search engine to query said first subset; and report, to the user, results comprising a second subset of the contents of said database, wherein said second subset is smaller than said first subset. As a further alternative, the response facilitation system of Szmanda, supra, is used to query the user to obtain one or more search rules comprising facts about an advertisement; access a database comprising details of a plurality of advertisements; use a search engine to apply the search rules to the database to obtain a plurality of results comprising a first subset of the contents of the database; receive, from the user, a first list of keywords; generate a second list of keywords, said second list comprising keywords synonymously related to one or more keywords in the first list; using the second list and a second search engine to query the first subset; and report, to the user, results comprising a second subset of the contents of said database, wherein the second subset is smaller than said first subset. As a further alternative, the response facilitation system of Szmanda, supra, is used to query the user to obtain one or more search rules comprising facts about an advertisement; access a database comprising details of a plurality of advertisements; use a first search engine to apply the search rules to the database to obtain a plurality of results comprising a first subset of the contents of the database; receive, from the user, a first list of keywords; generating a second list of keywords, the second list comprising keywords or phrases synonymously related to one or more keywords or phrases in the first list; use the second list and a second search engine to query the first subset; and report, to the user, results comprising a second subset of the contents of the database, wherein the second subset is smaller than the first subset.

As a further alternative, the customer response facilitation system can be a commercial recording and storage system (an advertisement recording system) such as that reported to be available from TiVo, Inc. of Alviso, Calif. in which commercial advertisements are stored and tabulated for later viewing by the customer. Inputs, initiated by the customer, which constitute the search, are used to select the advertisements to be viewed may be used by advertisers in accordance with the present invention.

As a further alternative, the customer response facilitation system can be a peer-to-peer operation in which paid representatives engage interested customers and provide the necessary response facilitation in on a face-to-face basis. In such a case, representatives, acting as facilitators would take care to record the customer's words used to make an inquiry. This interaction would constitute the search by asking the user to recall whether he or she has seen the advertisement in question. An added variable that may arise in peer-to-peer response facilitation is whether or not the customer knows the facilitator is working for the advertiser.

Computer based response facilitation services may employ a private network, accessed by authorized persons, or a public network such as the Internet. The private network can be accessed via the Internet, using secure connection technology, such as encryption, password protected access, virtual private network technology, or recognition of unique user identifiers such as, but not limited to personal details, fingerprints, retinal data, voice characteristics and the like. The public network may further be a peer-to-peer network wherein data are relayed from one peer unit to another and optionally to a central network such as the internet. Peer-to-peer networks support computers at a fixed location, telephony, whether mobile or at a fixed location, as well as mobile hand-held devices that support e-mail, internet, instant messages and the like. The public network can be the Internet or any other network available to the general public. Public or private networks can be accessed using a computer terminal, a personal computer interface, a public kiosk interface which might be found in a shopping venue or roadway rest stop or a wireless device such as a wireless telephone or a wireless Internet interface. The search engines of this invention can reside on a central host computer, a server, a plurality of mirror sites or locally on the user's computer. The advertisement database can reside on a central host computer, a server, a plurality of mirror sites locally on the user's computer or other network. The advertisement database can be in a single location, assembled from various dispersed sources on the Internet into a single virtual database or otherwise directed from a list of pointers to various dispersed sources on the Internet.

In the foregoing, a customer search would not be entered into the research unless the customer succeeded in finding at least one advertisement sought. When the customer does a search for an advertisement, he or she seeks a subset of advertisements within a given advertising universe and that subset may represent a single advertisement, a plurality of advertisements running in the same or different media, characterized in that they are meant to achieve saliency by using queues that have common elements, characterized in that they are meant to achieve saliency by using queues that have similar elements or characterized in that they are meant to achieve saliency by using queues that have entirely different elements. Alternatively, what is sought by the customer may be a plurality of advertisements running in the same or different media for the same product or service, different products or services within the same product family, different products or services from the same manufacturer, similar products or services from different manufacturers, or dissimilar products or services from the same or different manufacturers.

Individual customer inputs are made to the response facilitation system by each customer during each session. Customers who do multiple searches may generate a plurality of individual customer inputs provided these inputs are not repeated substantially. In most but not all cases, these are multivariate inputs made during each customer session. Further, such inputs need not be sufficiently specific to define a particular advertisement uniquely. Inputs include free-form descriptions of advertisements experienced by customers, such free form descriptions can be parsed by standard methods to yield keywords or phrases describing the advertisement in some way or the keywords or phrases can be entered directly, brand names or portions thereof, “sound-alike” or misspelled words capable of being interpreted by error-correcting software, a description of color schemes used in the advertisement, a description of the music heard in the advertisement, a description of the linguistic elements employed by the advertisement, a description of the ambient environment depicted in the advertisement, a description of the user's subjective impression after experiencing the advertisement, a description of visual queues perceived in the advertisement, a description of the plant, animal or human model or models used in the advertisement, a description of the cartoon or caricatured models used in the advertisement, a description of the item advertised, a description of the social situation depicted in the advertisement, a description of the tactile sensations conveyed by the advertisement, a description of the olfactory sensations conveyed by the advertisement, a description of the taste sensations presented by the advertisement, a description of the user's perception triggered by a sensory stimulus or a plurality of stimuli conveyed by the advertisement or a description of the user's impressions of the artistic elements presented in the advertisement or other descriptors characteristic of the advertisement. For purposes of description, keywords can be single words, phrases that are not full sentences or full interrogative, declarative or imperative sentences or any combination thereof. In the cases where a given keyword input by the user comprises a multiword phrase or a complete sentence, one of ordinary skill in the art would recognize that such phrases or complete sentences can be parsed to yield relevant single keywords using methods described in standard references such as James Allen, “Natural Language Understanding,” Addison Wesley, New York, (1999), chapters 2,3,6 and 7.

In the foregoing, an individual customer input, can be considered vector quantity because it includes one or more component variables. Such variables can represent numerical data such as real numbers, integers, dates and times or categorical data. Categorical data can be further characterized as ordinal data or nominal data. Ordinal data arise in situations where the values are naturally ordered, such as when one is describing the first, second and third year of a course of study or in situations where the customer expresses his or her reaction to a product or service, for example, on a scale of 1 to 10. Nominal variables are categorical variables for which there is no natural ordering. These include two-level responses such as yes or no, or male or female, as well as multi-level responses such as in describing marital status as married, divorced, never married, widowed etc. Multi-level variables can be represented as dummy variables; for each of which there are only two levels. For example, marital status can be represented as a yes or no answer for each of the responses such as married -yes, divorced -yes, never married -no, widowed -no, etc. In this way, each of the responses in a multi-level variable, becomes a two-level response for each dummy variable.

In the foregoing, a vector can have components that are numerical or categorical. In vectors with purely numerical components, it is possible to compute a Pythagorean distance directly. In addition, it is usually the case that one can compute directly a Pythagorean distance with ordinal variables. On the other hand, the computation of Pythagorean distances when vectors are purely nominal or certain types of ordinal values cannot usually be accomplished directly. In such cases, mappings of categorical variables onto numerical spaces are known and can be accomplished so as to allow distances to be computed within the numerical spaces. An example of such a procedure is set forth in Lebbah et al., “Categorical Topological Map,” ICANN 2002 (J. R. Dorronsoro, Ed.), LNCS 2415, pp. 890-895, 2002. Moreover, distances for mixed categorical and numerical data can be computed as set forth in Lebbah et al., “Mixed Topological Map,” ESANN'2005 proceedings—European Symposium on Artificial Neural Networks, Bruges (Belgium), pp. 27-29 April 2005. Such mappings enable the computation of distances on the numerical spaces to which the categorical variables have been mapped, which then can be used to evaluate accuracy and precision. Moreover, the mathematical application of function spaces can generally be applied as long as a mapping can me made to a basis set for which a distance and a norm can be calculated.

As used herein, the term “accuracy” is intended to covey the degree of closeness of a given vector, such as a customer input vector to the correct or targeted value. Advertisers frequently wish to gauge how accurately the chosen queues in advertising are influencing customers. Such measures can be applied directly with numerical data and as described supra by using mapping techniques with categorical data. However, it should not be inferred that a highly sophisticated analysis such as that above is necessary for the practice of this invention. For example, a simple 1 or 0 scale can be assigned corresponding to whether a given component of a customer input vector represents the advertiser's targeted value or not. For example, consider the case in which a customer uses a certain word in describing an advertisement and the advertiser has determined that the exact use of that word merits an assigned value of “1” and no other word merits such an assignment. In that case, the advertiser places a high premium on the exact use of the term. On the other hand, it is possible that the customer's input uses a term that is synonymously related to the term targeted by the advertiser and that such synonymously related terms merit a “1” value, or a value of 0.5. Such a measure can also be used to gauge accuracy for the customer's application. Synonymously related terms can be obtained from references such as “Partridge's Concise Dictionary of Slang and Unconventional English,” Macmillan Publishing Company, New York, (1984 edition), and/or “Roget's International Thesaurus,” Robert L. Chapman (Editor), HarperCollins, (1992 edition).

Accuracy can be evaluated within an entire set of data or within subsets of the data that have been sorted out from the original set. For example, a series of questions can be presented in the response facilitation session; the response to which produces data that allows sorting by demographics. For example, data allowing demographic segmentation can be collected in each session or can be stored in a cookie on the customer's computer to be accessed when future searches are performed to save the customer's time.

In addition, customer input vectors can be sorted according to the advertisements acknowledged to have been viewed by customers based on successful outcomes of a customer facilitation session. In this way, advertisers can gauge the ways in which the queues provided in their messages produce a sufficiently accurate recollection of the targeted advertisement particularly in, but not limited to, situations saliency or familiarity with a series of advertisements.

The connotative and denotative meanings of words and phrases can be tabulated and used to expand a keyword list, presented by the user to describe his or her experience with an advertisement, so that a larger, more inclusive list is generated. For the purposes of this specification, an expanded list can be described alternatively as a list of terms synonymously related to one another. To generate an expanded list or list of synonyms, such data as is contained in “Partridge's Concise Dictionary of Slang and Unconventional English,” Macmillan Publishing Company, New York, (1984 edition), and/or “Roget's International Thesaurus,” Robert L. Chapman (Editor), HarperCollins, (1992 edition) can be used.

As used herein, the term “precision” describes the spread of the data around a central tendency such as a numerical mean or average, a geometric mean, a median, a mode, regression coefficients and intercepts, and/or measures for which a standard error of estimate, variance or standard deviation can be computed. Further measures of precision can be performed by analysis of variance and covariance, multiple linear regression, multiple nonlinear regression, t-tests, F-tests, z-tests and statistical testing designed to evaluate search relevance. In addition to measures of precision that are suited for numerical variables, the precision of two level nominal variables can be gauged by known statistical methods such as logistic regression, wherein purchase intention/rating translations can be evaluated on the basis of explicit measures of confidence level and precision. Data from customer response facilitation can be subjected to logistic analysis using known methods, for example, as implemented in the program SPSS, available from SPSS Inc., Chicago, Ill. Precision can be evaluated for dependent categorical variables having two or more levels by employing the known method of discriminant analysis. In this technique, researchers can obtain the salient attributes consumers used to evaluate products in a given category using data obtained from a customer response facilitation system, use the known statistical quantity, Wilks's lambda to estimate the discriminant function coefficients and determine statistical significance and validity, plot the results on a map having two or more dimensions, where the dimensions span a spectrum of customer descriptions of advertising that they have experienced and evaluate results using perceptual mapping. In evaluating customer perceptions of automobiles, for example, the spectrum might range from classy and distinctive to practical and affordable on one axis and sporty to conservative on another axis. The distance one model of automobile is from another on such a scale can be used to gauge the perceived market segment into which a given automobile model falls. For example, the spread of luxury sport-utility vehicles may be relatively narrow, thus indicating a high precision, narrow market segment. On the other hand, mid-priced American automobiles may form a rather broad but distinct cluster while mid-priced foreign automobiles form another. Broad clusters would be a characteristic of lower precision. Such analyses can be performed using commercial software such as SPSS as described supra. Advertising can be used to influence the reliability of such positioning by introducing the desired amount of precision.

It should also be noted that the forgoing procedure can also be used to evaluate accuracy. In this case, the outcome of the analysis is evaluated against the advertiser's desired targeted position using data from a response facilitation system, sorting the customer input vectors as hereinabove described and comparing the results of discriminant analysis against the advertiser's desired position. Further, Logistic regression can provide measures of accuracy by evaluating the position of the central tendency against the advertiser's desired position within the marketplace. For example, luxury sport utility vehicles might appear high on the “classy and distinctive” scale and high on the “sporty” scale. Indeed, an advertiser encountering customer response facilitation data that suggested otherwise might be expected to modify his or her advertising in order to shift perceptions.

Further, Bayesian analysis can be used either on a first pass or repetitively to obtain positioning distributions that are increasingly reflective of the actual distributions. Such analyses can be carried out using simple histogram frequency procedures, any method capable of giving a central tendency such as regression, ANOVA logistic regression and discriminant analysis. In Bayesian analysis, the prior distribution is used to calculate a new, posterior probability distribution based on both prior knowledge and the available data. Initially, if nothing is known about the probability distribution, a simple guess of the distribution can be used. As more data are collected and put into the model, estimates of the actual distribution improve significantly. Such analyses can be used to evaluate accuracy by comparing the point of highest frequency with the advertiser's desired position. Measures of precision are provided by the breadth of the distribution. While such measurements can be arbitrary, the full width at half maximum is used frequently. Bayesian analysis can be used in conjunction with any of the foregoing statistical procedures and is set forth in such standard texts as MacKay, “Information Theory, Inference, and Learning Algorithms,” Cambridge University Press, 2003, chapters 2 and 37.

As a further refinement of the foregoing, longitudinal studies can be performed in which the accuracy and precision of the customer responses are evaluated repeatedly over time. In such longitudinal studies, changes in customer perception, accuracy of the message relative to the advertiser's desired perception and precision of the customer responses can be monitored.

Customer inputs having keywords or phrases can be input by typing; spoken into a voice recognition system capable of interpreting the input for the search engine; entered via a user interface comprising a pad having one or more real or virtual keys such as a typewriter style keyboard, a telephone keypad, or a touch screen; an electronic musical instrument; a handwriting recognition interface; a mouse; an eye movement sensor; or any other indicative means employed in computer interfaces.

In addition to initial customer inputs that are minimally prompted, iterative search results can be used. In such cases, the level of accuracy of the customer responses may increase upon prompting by the response facilitation system. While such prompting may bias data related to saliency, data related to more subtle queues may be elicited in a second round of questions from the response facilitation system as described by Szmanda, cited supra.

It is further contemplated that other marketing and/or advertising research activities than those described in detail can also be performed using one or more aspects of this invention as hereinabove described. For example, it is expected that this invention will be useful in test marketing, concept testing, mystery shopping, store audits, demand estimation, sales forecasting, customer satisfaction studies, distribution channel audits, price elasticity testing, segmentation research, consumer decision process, positioning research, brand name testing, brand equity research and advertising and promotion research. It is also contemplated that this invention can be practiced in the absence of any and all elements not specifically disclosed herein.

What is claimed is:

1. A method of facilitating advertising research, comprising: providing a plurality of individual customer inputs, said plurality of individual customer inputs being obtained from searches by one or more customers using a customer response facilitation system, and characterized in that the final output of each search session includes at least one advertisement sought by the individual customer; computing the accuracy of the customer inputs relative to the advertiser's targeted advertisement or advertisements; and computing the precision of the plurality of individual customer inputs.

2. The method of claim 1, wherein the accuracy and, optionally, the precision are computed using Bayesian analysis.

3. The method of claim 1, wherein the precision of the customer inputs is computed using at least one statistical method chosen from discriminant analysis, logistic regression, linear regression, nonlinear regression, analysis of variance or analysis of covariance.

4. The method of claim 1, further comprising: performing a longitudinal study wherein the accuracy and precision are evaluated repeatedly over time.

5. The method of claim 1, wherein the response facilitation system is chosen from a searched based system, an advertisement recording system or a peer-to-peer system.

6. A method of facilitating advertising research, comprising: providing a plurality of individual customer inputs, said plurality of individual customer inputs being obtained from searches by one or more customers using a customer response facilitation system, and characterized in that the final output of each search session includes at least one advertisement sought by the individual customer; sorting the inputs into groups according to one or more demographic segments; computing the accuracy of the customer inputs within in each group relative to the advertiser's targeted advertisement or advertisements; and computing the precision of the customer inputs within each group.

7. The method of claim 6, wherein the accuracy and, optionally, the precision are computed using Bayesian analysis.

8. The method of claim 6, wherein the precision of the customer inputs is computed using at least one statistical method chosen from discriminant analysis, logistic regression, linear regression, nonlinear regression, analysis of variance or analysis of covariance.

9. The method of claim 6, wherein the response facilitation system is chosen from a searched based system, an advertisement recording system or a peer-to-peer system.

10. The method of claim 6, wherein the one or more demographic segments are chosen from age, ethnic background, race, geographic location, sex, political preference, occupation, income, religion, sexual preference, avocations and hobbies, musical preference, entertainment preferences, education, economic status, distance from workplace, housing type and automobile preference or a combination of any of the foregoing.

11. The method of claim 6, further comprising: performing a longitudinal study wherein the accuracy and precision are evaluated repeatedly over time.

12. A method of facilitating advertising research, comprising: providing a plurality of individual customer inputs, said plurality of individual customer inputs being obtained from individual searches by one or more customers using a customer response facilitation system, and characterized in that the final output of each search session includes at least one advertisement sought by the individual customer; sorting the inputs into groups such that the final outputs of the search sessions in each group correspond to different advertisements; computing the accuracy of the sorted customer inputs within each group relative to the advertiser's targeted advertisement or advertisements; and computing the precision of the customer inputs within each group.

13. The method of claim 12, wherein the accuracy and, optionally, the precision are computed using Bayesian analysis.

14. The method of claim 12, wherein the precision of the customer inputs is computed using at least one statistical method chosen from discriminant analysis, logistic regression, linear regression, nonlinear regression, analysis of variance or analysis of covariance.

15. The method of claim 12, wherein the response facilitation system is chosen from a searched based system, an advertisement recording system or a peer-to-peer system.

16. The method of claim 12 further comprising: performing a longitudinal study wherein the accuracy and precision are evaluated repeatedly over time.
